(19) United States
(12) Patent Application Publication
(10) Pub. No.: US 2016/0123286 A1
(43) Pub. Date: May 5, 2016

(54) METHOD, SYSTEM, AND FUEL INJECTOR FOR MULTI-FUEL INJECTION WITH PRESSURE INTENSIFICATION AND A VARIABLE ORIFICE

(71) Applicants: Deyang HOU, Sugar Land, TX (US); QUANTLOGIC CORPORATION, Sugar Land, TX (US)

(72) Inventor: Deyang Hou, Sugar Land, TX (US)

(73) Assignees: Quantlogic Corporation, Sugar Land, TX (US); Deyang Hou, Sugar Land, TX (US)

(21) Appl. No.: 14/897,009

(22) PCT Filed: Jun. 9, 2013
(86) PCT No.: PCT/US2013/044863

§ 371 Date: Dec. 9, 2015

Related U.S. Application Data
(60) Provisional application No. 61/657,796, filed on Jun. 10, 2012.

(51) Int. Cl. F02M 43/04; F02M 61/10; F02M 61/18; F02M 25/03; F02M 51/06

(52) U.S. Cl. CPC F02M 43/04; F02M 25/03; F02M 51/06; F02M 61/18; F02M 61/10

(57) ABSTRACT

A multi-fuel injector has an internal pressure intensifier which has means to intensify fuels with different viscosities, cetane or octane numbers, with high viscosity fuel being used to intensify itself and low viscosity fuels to high pressure for direct injection into combustion chamber. A fuel injection method and fuel system using such a method of fuel injection is disclosed. A multi-fuel injector with a variable orifice nozzle and variable spray patterns is also disclosed.

### CROSS REFERENCE TO RELATED APPLICATION

This application is the National Stage Entry of PCT/US2013/044863.

### TECHNICAL FIELDS

This invention related to a fuel injector, method and system of direct fuel injection for single fuel and multiple fuels, especially for internal combustion engines.

### BACKGROUND OF THE INVENTION

### Description of the Related Art

The combustion process in a conventional direct injection Diesel engine is characterized by diffusion combustion with a fixed-spray-angle multi-hole fuel injector. Due to its intrinsic non-homogeneous characteristics of fuel-air mixture formation, it is often contradictory to simultaneously reduce soot and NO sub(x)formation in a conventional diesel engine. Progress has been made in recent years for advanced combustion modes, such as Homogeneous-Charge Compression-Ignition (HCCI) combustion and Premixed Charge Compression Ignition (PCCI). However, many issues remain to be solved to control the ignition timing, the duration of combustion, the heat release rate of combustion for HCCI and PCCI engines for various load conditions. It seems to be a more viable solution to operate engine in mixed-mode combustion, or in HCCI mode or partially premixed mode at low to medium loads, and in conventional diffusion combustion mode at high loads for the near future. Or, we can use mixed-mode combustion even in same power cycle, such as proposed by the inventor in U.S. patent application Ser. No. 12/143,759.

A key challenge for mixed-mode combustion with conventional fix-angle multi-hole nozzle is surface wetting for early injections. There are many inventions (for example, PCT/EP2005/054057) could provide dual spray angle multiple jets spray patterns with smaller angle for early injections and larger spray angle for main injections. However, researchers find that, even with smaller jets for very earlier injections, the conventional multiple jets spray still tend to wet the piston top and thus could cause emission issues such as hydrocarbon and mono-dioxide (SAE paper 2008-01-2400). This observation especially tends to be true for passenger car engines where cylinder diameter is small.

A high pressure injection at late cycle could potentially eliminate the wall wetting while ensuring fine atomization with conventional nozzles. Alternatively, a variable spray pattern injection, which provides softer hollow conical spray for early injection and conventional multiple jets for late injection, can also significantly reduce or eliminate wall wetting issues.

To reduce carbon dioxide emissions, bio-fuels production such as ethanol and biodiesels have increased. Researchers have found that using ethanol with diesel fuel can reduce both soot and nitride oxide emissions. Currently, most ethanol-diesel dual fuel applications are practiced with one type of fuel injected in intake ports, another type of fuel injected into cylinder directly, with a different set of fuel injectors for each fuel. Injecting both bio-fuel and diesel fuel directly into cylinder with a single injector capable of dual fuel injection could potentially cut the complexity and cost of the fuel system, and further leverage the benefits of different fuel properties for optimizing combustion.

Low temperature combustion (LTC) becomes one of the most promising near term strategy to improve engine efficiency and lower emissions. Thus LTC sparks major R&D efforts among industries and academia. The LTC produces improved thermal efficiency due to reduced thermal loss and provides lower emissions of NO sub(x) and PM. Currently, there are two major approach of using gasoline/ethanol on a diesel engine platform: intake port injection of gasoline/ethanol, and direct injection of blended gasoline/ethanol with diesel fuel. Most recently, researchers have conducted extensive research work through combing port injection of gasoline/ethanol and direct injection of diesel fuel on a diesel engine platform, and demonstrated an impressive efficiency improvement. While port injection of gasoline/ethanol only demands low pressure gasoline fuel injection systems, engine experiment data also demonstrated high HC and CO emissions. Blending gasoline/ethanol with diesel for direct injection seems promising but comes with the concerns for the durability of diesel fuel injection equipments.

We can anticipate that, with on-demand direct injection of dual-fuel gasoline or ethanol-diesel, we can eliminate issues related port injection of gasoline/ethanol, such as high HC, CO and cold starting difficulties, etc. It is also expected to significantly extend the LTC operation map with high pressure direct injections of both diesel and gasoline fuels. Due to lacking a practical dual-fuel injector for direct injection applications, on-demand separately direct injection of both gasoline/ethanol and diesel fuel without pre-blending is rare in literature. However, direct injection is considered as most promising.

Conventional direct fuel injections for low viscosity fuels such as gasoline and ethanol can only be done through early injection using relatively low pressure generally below 200 bars, and this is sufficient for most direct injection gasoline engines due to the low compression ratios. However, to further explore high efficiency combustion using low viscosity fuels on diesel platform with high compression ratios without knocking concerns, further high pressure late cycle injection is needed even for gasoline or ethanol fuels. A single injector with multi-fuel or dual fuel high pressure injection can eliminate the need for two set of fuel injectors dedicated for each fuel, thus improve simplicity and reduce the overall cost of the dual fuel engine platform. Dual fuel direct injection can also eliminate the difficulty of cold starting, and issues related to port injection and fuel blending.

### SUMMARY OF THE INVENTION

Thus, it is our goal of this invention to leverage different fuel properties, variable spray patterns, and fuel pressure intensifications to:
(1) use diesel fuel or other high viscosity fuels as a pressure intensifying fuel for enabling high pressure injection of low viscosity fuels, such as gasoline, ethanol, or gasoline and ethanol blends, and LNG; (2) use diesel fuel as a lubricant for sliding surfaces for injection of low viscosity fuels. (3) use low pressure pump for supplying gasoline or other low viscosity fuels, use a novel internal pressure intensifier within injector to significantly boost the pressure of gasoline, with a capability to reach high pressure gasoline direct injection such as 1500 bar, this is made viable through using diesel fuel as lubricant for key sliding surfaces; (4) the high injection pressure capability enables higher compression ratio for engine and late injections, thus reduces the concerns of engine knocking, reduces carbon monoxide and hydrocarbon emission, extends the Brake Mean Effective Pressure (BMEP) map of low temperature combustion; this also enables the converging of gasoline and diesel engine base platforms; (5) generating variable spray patterns such as hollow conical and multiple jets on demand to optimize spray patterns for different injection timings and engine loads.

The above and following discussions, whenever being focused on gasoline-diesel, should be considered as extendable to other low viscosity fuel such as ethanol, LNG, etc, and high viscosity fuels such as bio-diesel, JP-8, etc, with appropriate customizations. Thus, the discussions with specific fuels are not intended to limit the scope of applications for the inventions for different fuel combinations.

### BRIEF DESCRIPTION OF THE DRAWINGS

FIG. 1 is a simplified illustration of the fuel injection method using pressure intensification for fuels with different viscosities.

FIG. 2 is a simplified illustration of the fuel injection method using pressure intensification for fuels with different viscosity. FIG. 2 is same as FIG. 1 except fuel having low viscosity has been injected with a lower injection pressure than the high viscosity fuel due to the intensifier design with a smaller end facing high viscosity fuel.

FIG. 3 is an exemplary embodiment of a duel fuel system using pressure intensification for delivering fuels with different viscosities.

FIG. 4 is a simplified illustration of the intensification plunger with different face areas and fuel combinations with different viscosity and pressures.

FIGS. 5 and 6 are a cross-sectional view of an exemplary embodiment of an injector of the invention, referred as multi-fuel unit injector, with only one electronic control valve for pressure intensifier.

FIG. 7 is a bottom view of the spray pattern emerged from the fuel injector of FIG. 6 under different needle lifts and needle valve fuel injection passage configurations.

FIG. 8 is a cross section view (A-A of FIG. 6) of the fuel injection passages in the nozzle body, with one as open channel (a), another as closed hole (b).

FIG. 9 is the detailed illustration (B view of FIG. 6) for the nozzle tip of the fuel injector.

FIGS. 10 (a) and (b) is an illustration of the fuel stream interaction.

FIG. 11 is an illustration of the states of a variable orifice during fuel injection process.

FIG. 12 is a cross-sectional view of an exemplary embodiment of an injector of the invention, referred as multi-fuel common rail injector, when the needle is at seating position, no fuel is being injected.

FIG. 13 is a cross-sectional view of an exemplary embodiment of an injector of the invention, referred as multi-fuel common rail injector, when the needle is at lifted position, fuel is being injected.

FIG. 14 is a cross-sectional view of an exemplary embodiment of an injector of the invention, referred as simplified multi-fuel injector, when the needle is at lifted position, fuel is being injected.

In all the figures,
F1—high pressure common rail for high viscosity fuel; F2—high pressure fuel pump; F3—filter; F4—low pressure fuel pump for high viscosity fuel; F5—fuel cooler; F6—fuel tank for high viscosity fuel; F7—low pressure common rail for low viscosity fuel; F8—fuel tank for low viscosity fuel; F9—low pressure fuel pump for low viscosity fuel; F10—fuel injector; F101—intensifier piston; F102—pressure intensifying chamber; F103—pressure intensification chamber; F104—fuel spray of low viscosity fuel; F105—fuel spray of high viscosity fuel; F 11—combustion chamber; F100—low pressure delivery loop section for high viscosity fuel; F200—high pressure delivery loop section for high viscosity fuel; F300—low pressure delivery loop section for spent return high viscosity fuel; F400—low pressure delivery loop section for low viscosity fuel; F500—low pressure delivery loop section for spent return low viscosity fuel;
1000—nozzle assembly; 2000—nozzle needle lift control chamber; 3000—needle control electronic valve; 4000—pressure intensifier; 5000—electronic control valve for pressure intensifier;
1—nozzle; 2—needle; 3—injector body cap; 4—needle control chamber and spring holder; 5—O-ring; 6—needle lift control spring; 7—adaptor; 8—connector; 9—check valve for low viscosity fuel; 10—pressure intensifier holder; 11—pressure intensifier plunger; 12—pressure intensifier piston spring; 13—pressure intensifier piston; 14—solenoid control valve body; 15—common rail for high viscosity fuel; 16—electrical wires; 17—solenoid for pressure intensifier; 18—spring for solenoid valve plunger; 19—solenoid plunger valve; 20—fuel supply passage in plunger valve; 21—intensifying chamber; 27—nozzle fuel injection passages;
101, 102, 103—fuel passages for pressured high viscosity fuel;
1011—pressure intensifier inner sliding surface in contact with high viscosity fuel;
1012—pressure intensifier inner sliding surface next to low viscosity fuel;
1013—pressure intensifier inner sliding surface;
1031—fuel passage inside spring holder; 1032—fuel passage inside the nozzle; 1033—fuel passage inlets inside the needle; 1034—fuel passage along center of the needle; 1035—nozzle orifice;
1036, 1037, 1038—high pressure fuel passages; 1039—needle fuel injection passages;
1040—first type of fuel in hollow conical spray; 1041—second type of fuel in hollow conical spray; 1050—nozzle body valve seat; 1050′—needle valve seal surface 104—spent fuel passage; 105—fuel passage in nozzle;
110, 111—fuel passages of high viscosity fuel leading to intensification chamber 22;
112—high pressure fuel outlet from intensification chamber 22;
1102—lower outer cylindrical surface of plunger 11;
22—pressure intensification chamber for high viscosity fuel; 23—low viscosity fuel rail or reservoir;
2301—fuel passage connected to pressure intensification chamber 24; 2302—fuel passage connected to nozzle; 2303—fuel passage connected to low viscosity fuel reservoir;
24—low viscosity fuel intensification chamber; 25—needle sliding surface; 26—pressure chamber in nozzle; 27—nozzle sealing surface; 28—nozzle fuel multihole outlets;
2801—first type of fuel in multijet spray; 2802—second type of fuel in multijet spray;
29—needle tip shield; 31, 32, 33—needle control solenoid valve components, 31—solenoid, 32—plunger valve, 33—spring; 34—check ball for needle lift control; 35—needle control chamber seal ring; 41—check valve for high viscosity fuel;
501—needle control pressure chamber; 502—needle control fuel release passage; 503—spent fuel passage;

### DETAILED DESCRIPTION OF THE PREFERRED EMBODIMENTS

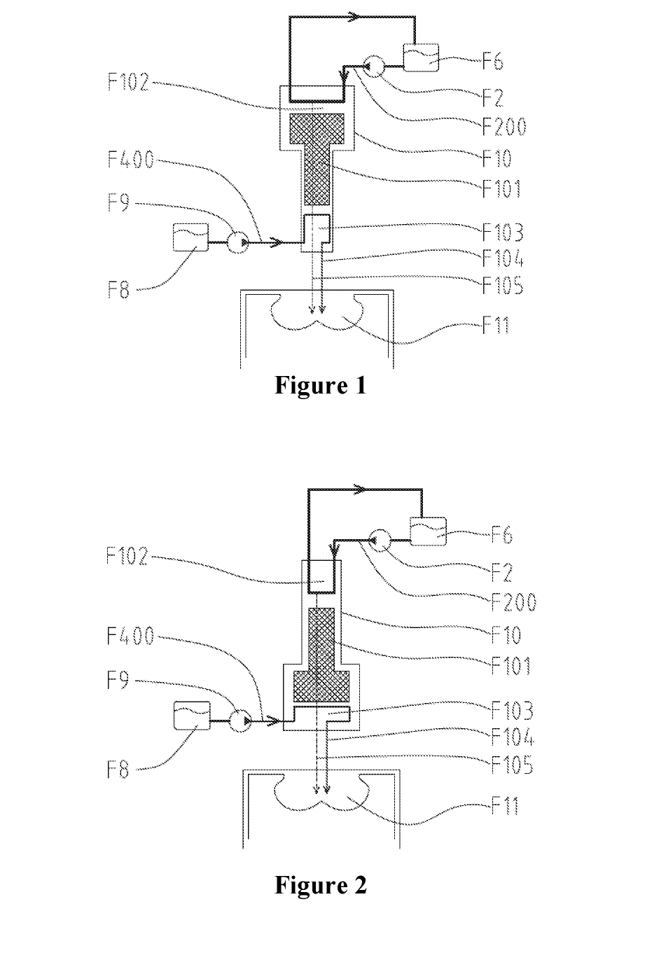

Referring to FIG. 1, the high pressure loop (F200) deliver a fuel having higher viscosity such as diesel fuel (F6) using a high pressure pump (F2) to intensify the fuel having low viscosity such as gasoline (F8) delivered from the low pressure pump (F9). The low viscosity fuel has been pressurized by high viscosity fuel within pressure intensification chamber (F103) of a fuel injector (F10), and both low viscosity fuel and high viscosity fuels (F104, F105) are directly injected into engine combustion chamber (F11) through fuel injector (F10). In this specific illustration, fuel with low viscosity has been injected with a higher injection pressure than the high viscosity fuel due to the intensifier design with a larger end facing high viscosity fuel.

FIG. 2 is same as FIG. 1 except fuel having low viscosity has been injected with a lower injection pressure than the high viscosity fuel due to the intensifier design with a smaller end facing high viscosity fuel.

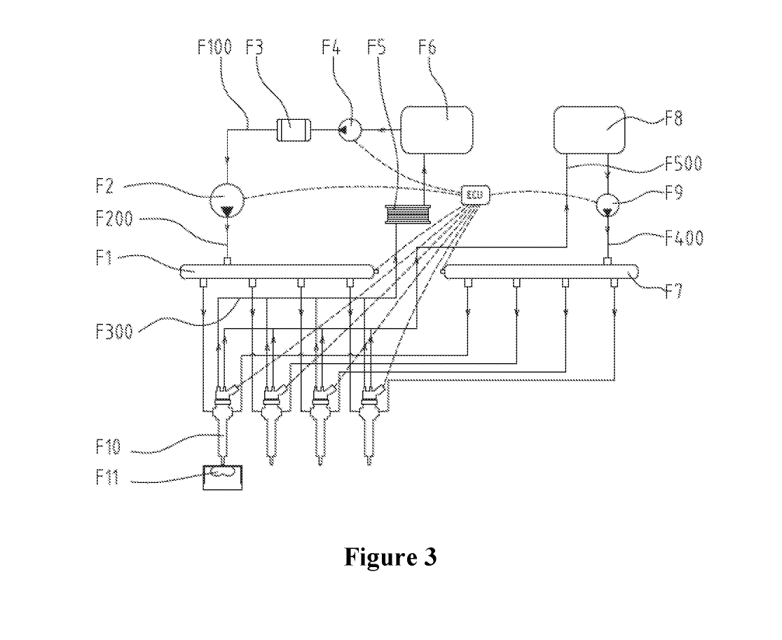

Referring to FIG. 3, which is an exemplary embodiment of a duel fuel system using pressure intensification for delivering fuels with different viscosities. The fuels being delivered can be diesel and gasoline, diesel and ethanol, or even gasoline with lubricant enhancer and regular gasoline fuels. The high pressure loop (F200) deliver a fuel with higher viscosity such as diesel fuel (F6) using a high pressure pump (F2). Low viscosity such as gasoline (F8) is delivered by a low pressure pump (F9). The low viscosity fuel has been further pressurized by high viscosity fuel within the fuel injector through an intensifier as illustrated in FIG. 1 within the fuel injector. Both low viscosity fuel and high viscosity fuels are directly injected into engine combustion chamber (F11). The high pressure loop (F200) and the low pressure loop (F400) has a common rail reservoir (F1) and (F2), respectively. Both the low viscosity fuel and high viscosity fuel which can bear different cetane numbers are directly injected into engine chamber (F11) through a fuel injector (F10). The fuel pressurization and injection process are controlled by an engine control unit (ECU).

The following section give a detailed discussion related to embodiments of pressure intensifiers of the fuel injectors of this invention.

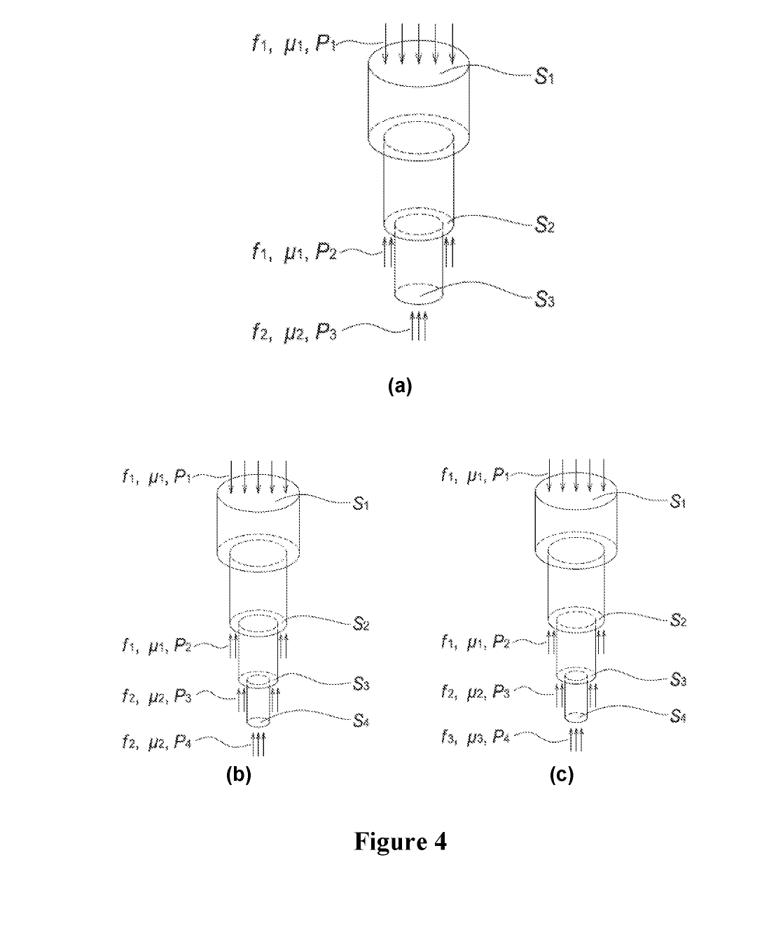

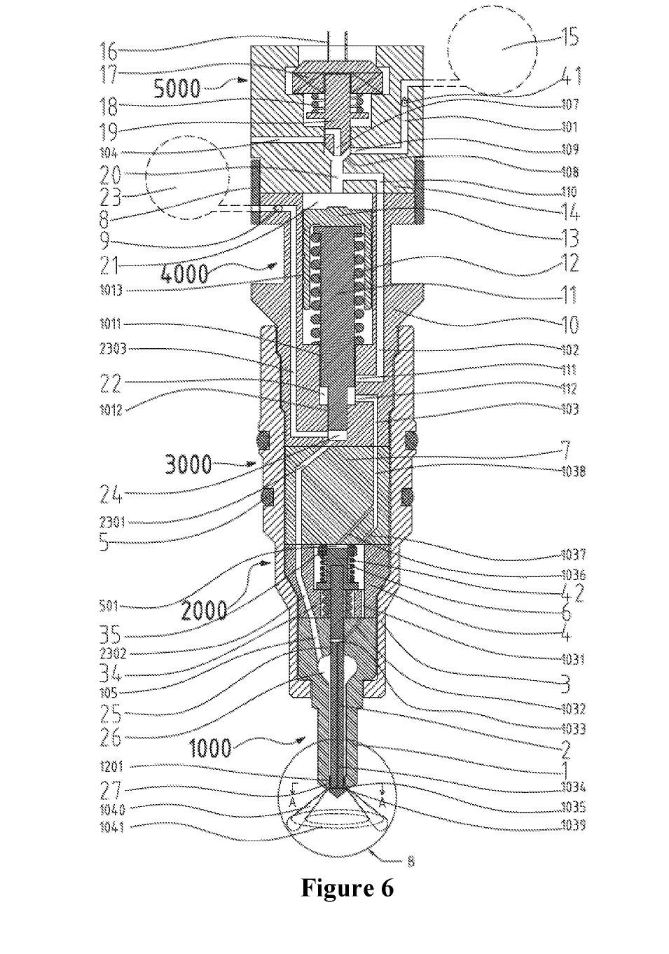

Referring to FIG. 4 (a), which is an illustration of the intensification plunger with different face areas of S1, S2, S3, as contained in the fuel injector illustrated in FIG. 1. For simplicity, the top cylindrical piston with area S1 should be considered as the assembly of the piston (13) and the plunger (11) in FIG. 1-3, and FIG. 6-11. S1, S2 is facing fuel with higher viscosity miu(sub)1, S3 is facing fuel with low viscosity miu (sub)2. In practice, S1 can be greater than S3 for pressure intensification for pressure P3, or make P3 greater than P1. However, if needed, S1 can be smaller than S3 for pressure intensification ratio less than 1, or P3 is less than P1. (b) is an illustration of the intensification plunger with different face and shoulder areas of S1, S2, S3, S4, with two types of fuels with viscosity miu(sub) 1 and miu (sub) 2 being intensified; (c) is an illustration of the intensification plunger with different face and shoulder areas of S1, S2, S3, S4, with three types of fuel bearing viscosity of miu(sub) 1, miu (sub) 2 and miu (sub) 3 being intensified. In practice, S1 can be greater than S2, S3, S4, or P4 is greater than P1. S1 can also be smaller than S2, S3, S4 to produce a pressure intensification ratio less than 1, or P4 is less than P1.

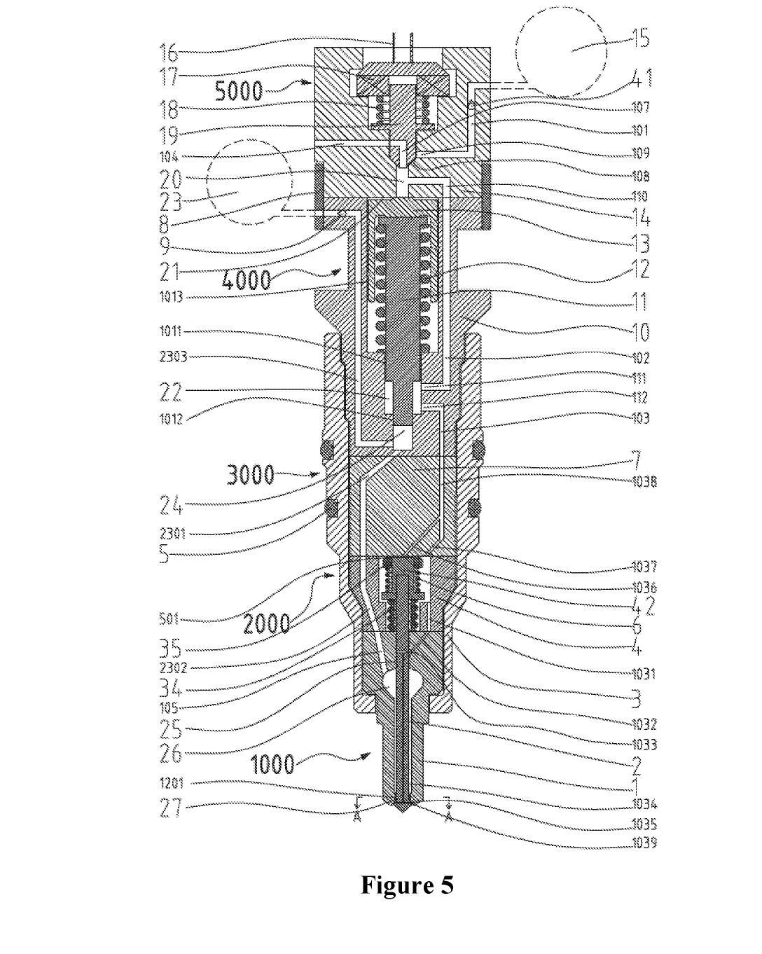

Referring to FIGS. 5 and 6, which are cross-sectional views of an exemplary embodiment of an injector of the invention, referred as multi-fuel unit injector, with only one electronic control valve for pressure intensifier. FIG. 5 is for the injector at no-injection state. FIG. 6 is for the injector at fuel injection state, with a passive nozzle and needle being at lifted position, with fuel being injected.

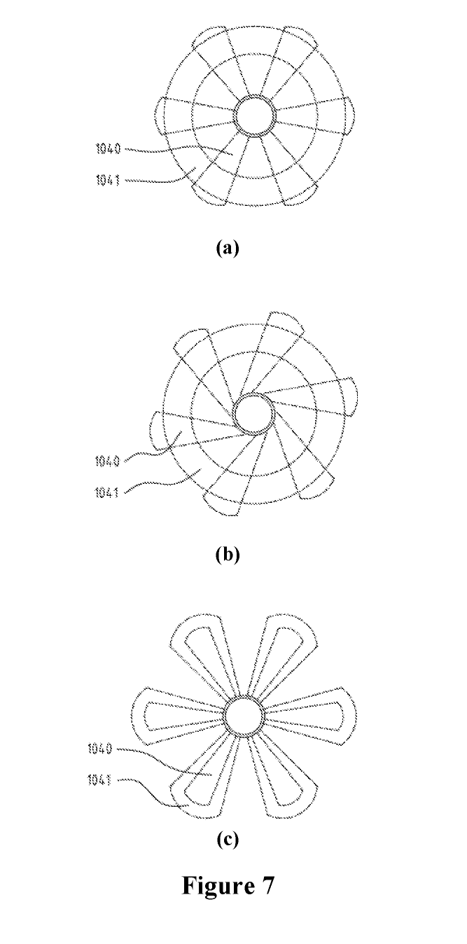

Referring to FIG. 7, which is a bottom view of the spray pattern emerged from the fuel injector of FIG. 6 under different needle lifts and needle valve fuel injection passage configurations. FIG. 7 (a) is a combination of hollow conical spray (1041) for a first fuel and flatted multiple jets (1040) for a second fuel. FIG. 7(b) is same as (a) except the multiple jets have rotational flow. FIG. 7(c) is a combination of overlapped multiple jets for two sprays (1041, 1040).

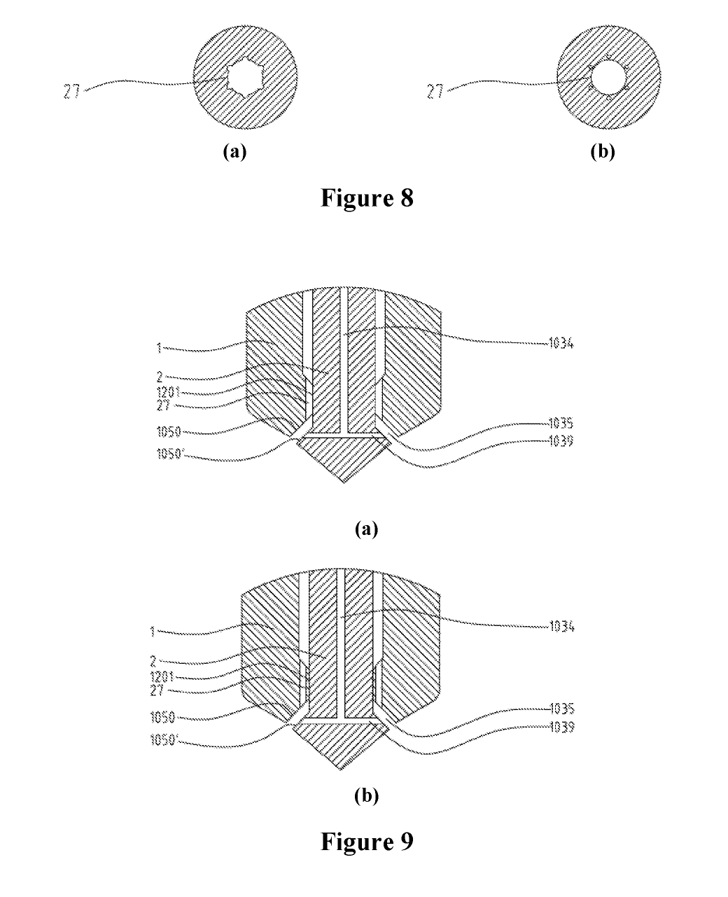

FIG. 8 is a cross section view (A-A of FIG. 6) of the fuel injection passages in the nozzle body, with one as open channel (a), another as closed hole (b).

Referring to FIG. 9, which is the detailed illustration (B view of FIG. 6) for the nozzle tip of the fuel injector. Two fuel streams are injected through fuel injection passages (27, 1039) in nozzle body and needle respectively, the two fuel streams are mixed within nozzle orifice (1035), and emerged from the orifice with different spray patterns and angles for optimizing engine combustion.

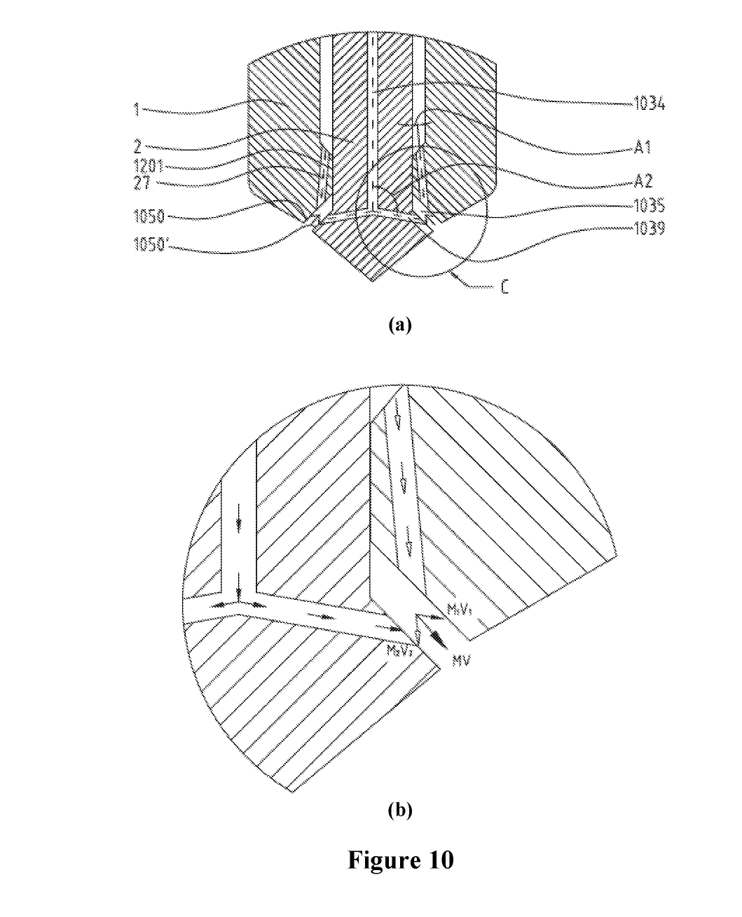

Refer to FIGS. 10 (a) and (b), which is an illustration of the fuel stream interaction. Two fuel streams carrying momentums (M1V1) and (M2V2) are interacted and mixed become a mixture fuel stream with total momentum (MV). Note that the fuel injection passages on nozzle body has an angle A1 between its axis and needle central longitudinal axis, fuel injection passages on needle valve has an angle A2 between its axis and needle central longitudinal axis. The variable spray pattern injection, which can provide softer hollow conical spray for early injection and conventional multiple jets for late injection, can significantly reduce or eliminate wall wetting issues.

The following sections give a detailed discussion related to general fuel injection methods of this invention.

Referring to FIG. 6, low pressure gasoline flow into the fuel injector from a low pressure fuel rail (23) through fuel passage (2301) and is filled in the pressure intensification chamber (24). When the solenoid valve (17) is turned on, the control valve plunger (19) was lifted, high pressure diesel fuel or other high viscosity fuel from common rail (15) flows into intensifying chamber (21), diesel fuel is also filled in the diesel intensification chamber (22) through passage (102) and is guided through fuel passages (103, 1031, 1032, 1033) to needle tip along the fuel passage in needle center (1034) and needle small fuel injection passage or needle orifice (1035), at the same time, pressure intensifier piston (13) and intensifier plunger (11) are intensified and are pushed downward quickly, both the gasoline and diesel fuel in the intensification chambers (22, 24) are further pressurized. The check valve (9) blocks out gasoline backward flow, the gasoline pressure in nozzle chamber (26) raises. The elevated pressure of diesel fuel in pressure chamber (501) conquers the upward spring force and lifts the nozzle needle (2) outward or downward, fuel injection begins with major gasoline fuel injected through nozzle body fuel injection passages (27), diesel fuel is injected from fuel injection passages (1039) in needle valve. The gasoline fuel stream and diesel fuel stream are further mixed within the nozzle orifice (1035), and are injected into combustion chamber as a duel fuel mixture. After metering the desired injection fuel quantity based on pulse-width map, the solenoid valve (17) closes, thus it closes the control valve (19), partial fuel from intensifying chamber (21) flows into low pressure fuel passage (104) through fuel passage (20, 107), the pressure in the intensifying chamber (21) reduces. The pre-pressed plunger spring (12) pushes back the intensifier piston (13) to top stop position, the pressure in needle control pressure chamber (501) is reduced. The spring (34) under the nozzle needle (2) conquers the reduced pressure force, the needle (2) returns to seat, fuel injection ends.

The fuel circuit for diesel fuel can be designed such that only intensification can trigger the needle lift. It is also designed such that there is an injection phase delay for diesel fuel than gasoline fuel (vice versa can be done too). In another word, fuel injection starts with major gasoline fuel and ends with fuels containing major diesel fuel for ignition purpose. The diesel fuel simultaneously serves as lubricant for the plunger and nozzle needle sliding surfaces (1011, 1012, 1013, 25) and needle seat (1050), and intensification fuel for pressure intensifier (4000). This eliminates concerns about the wearing of the nozzle due to low viscosity of gasoline or other low viscosity fuels. This simple lubrication concept is fundamentally important to ensure durability and thus make it viable for the high pressure injection of low viscosity fuel such as gasoline fuel, which otherwise may not be possible. The integrated triple rules for diesel fuel—lubricant, intensification, and ignition improver, are the key innovative design concepts to enable a high pressure injection event for low viscosity gasoline/ethanol fuels without durability and ignition concerns.

By switching the supply line of gasoline and diesel through a 2-way solenoid valve, the multi-fuel injector can be a single fuel injector with fuel injection modulated at different pressure level. By different configurations for the pressure intensifier area ratios as shown in FIG. 4, and materials, the injector can be customized for different dual-fuel/multi-fuel combinations, including gasoline-diesel, ethanol-diesel, ethanol-biodiesel, LNG-diesel, etc. The disclosed injector design is highly modular and adaptable.

With right selection of materials and intensification ratios, the injector can inject fuels with up to 3000 bar pressure, further increasing pressure is possible. For example, with common rail pressure setting at 1000 bar, a pressure intensifier intensification ratio of 3, the pressure at nozzle tip is close to 3000 bar. This performance is difficult to accomplish with conventional common rail system. Thus, the innovation proposed here, can provide high pressure injection of low viscosity fuels and high viscosity fuels, and open new advanced engine combustion regimes.

For applications, most engine loads will demand an injection pressure much less. For light duty driving cycles, the diesel common rail pressure is expected to be set at 100-300 bar, which will normally produce a nozzle tip injection pressure by the pressure intensifier to about 300-900 bar for gasoline and diesel fuels. We only need a low pressure gasoline pump (same to port fuel injection or PFI) due to the pressure intensifier (4000). This can significantly improve durability and reduce parasitic loss, it also reduces cost.

Following paragraphs are summaries for key inventions embodied in this disclosure.

Statement A: we propose a fuel injection method, comprising steps of: (i) supplying a fuel injector with at least one low pressure fuel with low viscosity, (ii) using a pressurized fuel with high viscosity from a pressure reservoir to intensify the low viscosity fuel in an intensification chamber within the fuel injector through a pressure intensifier having piston surfaces facing high viscosity fuel and low viscosity fuel, (iii) directly injecting the intensified low viscosity and high viscosity fuels into a combustion chamber through an injection nozzle.

A fuel injection method, comprising steps of: (i) supplying a fuel injector with at least one steam of fuels, (ii) injecting at least two sprays of fuels with at least one spray exiting from nozzle needle valve and another spray exiting from nozzle body, (iii) interacting fuel sprays at nozzle orifice exits such that different sprays patterns and angles are formed to fit for different injection timings.

A fuel injection method of “Statement A”, further comprising steps of: supplying a fuel injector with multiple low pressure fuels with different viscosities, cetane numbers, and octane numbers, into pressure intensification chambers, and directly injecting the intensified fuels with different cetane numbers and octane numbers into combustion chamber through an injection nozzle.

A fuel injection method of “Statement A”, further comprising steps of spraying fuels with different cetane number and octane number separately and directly into combustion chamber.

A fuel injection method of “Statement A”, further comprising steps of supplying high viscosity fuels to lubricate sliding surfaces of the fuel injection devices contacting low viscosity fuels.

A fuel injection method of “Statement A”, wherein the low viscosity fuels are at least one of gasoline fuels, ethanol fuels, and mixture of gasoline and ethanol, and the high viscosity fuel is a type of diesel fuels, biodiesel fuels.

A fuel injection method of “Statement A”, wherein the low viscosity fuels are at least one of liquid natural gas, compressed natural gas fuels, and the high viscosity fuel is a type of diesel fuels, biodiesel fuels.

A fuel injection method of “Statement A”, wherein the low viscosity fuels are gasoline like fuels, and the high viscosity fuel is a gasoline like fuel with an added lubricant enhancer.

A fuel injection method of “Statement A”, wherein the low viscosity fuels are injected at lower injection pressure than the high viscosity fuel.

A fuel injection method of “Statement A”, wherein the low viscosity fuels are injected at higher injection pressure than the high viscosity fuel.

A fuel injection system, comprising a high pressure fuel loop circulating fuel with high lubricity, and a low pressure fuel loop supplying fuel with low lubricity, wherein the the high pressure fuel loop is comprised of at least one high pressure fuel pump and a high pressure common rail, wherein the low pressure fuel loop is comprised of at least one low pressure fuel pump to supply low pressure fuel, a set of fuel injectors wherein the low lubricity fuel is being pressurized by the high lubricity fuel within the fuel injector through a pressure intensifier, and part of the high lubricity fuel and low lubricity fuels are being directly injected into an engine combustion chamber, an engine control unit (ECU) to control the fuel delivery and injection process.

Statement B: A fuel injector, comprising:
1. a nozzle body (1) comprising fuel supply passages connected to at least one pressurized fuel reservoir, an inner cylindrical space within the nozzle body for receiving a needle valve (2), and a plurality of fuel injection passages (27) to introduce fuel into combustion chamber, and a valve seat (1050), and
2. a needle valve (2), which has an longitudinal fuel passage within and has a plurality of fuel injection passages (1039) to inject fuel, the needle valve is movable back and forth and partially received in the nozzle body, the needle valve has a diverging-converging arrow-shape needle head which is larger than the narrowest part of the nozzle inner space, the needle head bears a seal surface (1050′) which can engage with valve seat at nozzle body and which guides fuel sprays, wherein the needle valve is at a biased closing position with its seal surface being pressed against the valve seat at the nozzle body (1) to block fuel flow from both the fuel injection passages on the needle valve and the nozzle body, or at an opening position through lifting the the needle valve seal surface outwardly away from the nozzle valve seat to inject fuel from fuel injection passages in both needle valve and nozzle body, and
3. an nozzle orifice (1035) for mixing and discharging the fuels from the fuel injection passages from the needle valve and the nozzle body in variable spray patterns through the gap between the needle valve and the nozzle body by lifting the needle valve outwardly at different magnitudes away from the valve seat.

A fuel injector of “Statement B”, wherein it has fuel supply passages connected to a single type of fuel, with pressurized fuel being supplied to the fuel injection passages in nozzle body and the needle valve respectively, wherein these two fuel injection streams are mixed and injected through the nozzle orifice (1035). A fuel injector of claim 12, wherein it has separate fuel passages connected to two type of fuels, with one type of fuel being supplied to the fuel injection passages in nozzle body while another type of fuel being supplied separately to fuel injection passages in the needle valve, wherein these two fuel streams are mixed and injected through the nozzle orifice (1035).

Statement C: A fuel injector of “Statement B”, referred as a fuel injector with an pressure intensifier, comprising: (i) a pressure intensifier, wherein it has means to intensify fuels with different viscosities and cetane numbers, with at least one high viscosity fuel being used to intensify low viscosity fuels to high pressure for directly injecting into combustion chamber, wherein there are multiple pressure intensification chambers and a cylindrical piston comprising different diameters with faces and shoulder surfaces having different sizes, with at least one surface facing and being driven by a high viscosity fuel, and at least one of the other piston faces and shoulder surfaces facing and pressurizing low viscosity fuels, (ii) an electronic control valve to control fuel flows from a pressurized fuel reservoir into an intensifying chamber of the the pressure intensifier and pressurize and depressurize the fuels in the pressure intensifier according to predefined electronic control valve positions.

A fuel injector of “Statement C”, refereed as a multi-fuel common rail injector, further comprising: (i) an electronic control valve to control the needle valve lift of the injection nozzle, (ii) fuel passages supplying high viscosity fuels to needle sliding surfaces, wherein it has means of directly injecting fuels with different viscosities and cetane numbers into an engine combustion chamber.

A fuel injector of “Statement C”, refereed as a multi-fuel unit injector, further comprising: (i) at least one spring to passively control the needle valve lift of the injection nozzle, (ii) fuel passages supplying high viscosity fuels to needle sliding surfaces, wherein it has means of directly injecting fuels with different viscosities and cetane numbers into an engine combustion chamber.

A fuel injector of “Statement B”, wherein the fuel injection passages in nozzle body are open fuel channels bearing an angle greater than zero to the longitudinal axis of the needle valve.

A fuel injector of “Statement B”, wherein the fuel injection passages in nozzle body are closed fuel holes, fuel passages in the needle valve are tangentially distributed to generate a swirl motion for injected fuel.

A fuel injector of “Statement B”, further comprising,
(1) a micro-variable-circular-orifice comprising a variable annular ring aperture (1035) between the needle valve and the nozzle body through lifting the needle valve outwardly away from nozzle seat such that fuels are dischargeable in variable sprays of hollow conical and multiple jets shapes and spray angles through the micro-variable-circular-orifice by lifting the needle valve at different magnitudes and through setting injection pressure at different levels to produce different spray momentum for fuel sprays coming out from fuel injection passages in the nozzle body and the needle valve. (2) A piezo actuator to control the needle lift.

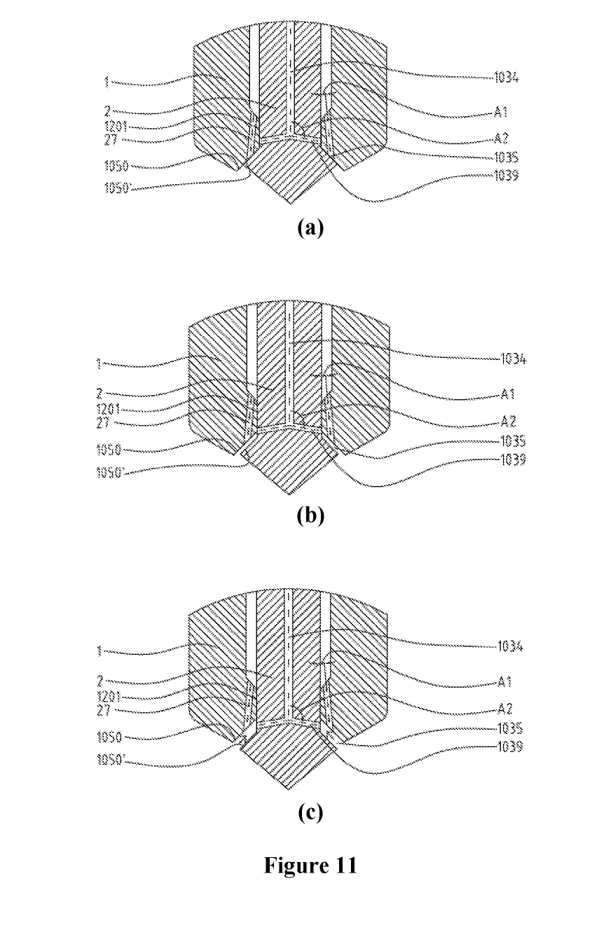

Referring to FIG. 11, which illustrates an embodiment of a variable orifice at different injection states. (a) is no-injection state, wherein needle valve is at the seating position, all fuel injection passages (1039, 27) in needle and nozzle body are fully blocked. (b) is a partial needle lift state, wherein only partial fuel injection passages (1039) in needle valves are uncovered while all fuel injection passages in nozzle body are open; (c) is a full needle valve lift states, wherein all the fuel injection passages in needle valve and nozzle body are open. The different fuel injection states offer different fuel mixture ratios and spray patterns and injection rates to enable engine combustion optimization. The sliding surface (1201) provides a good guidance for needle valve (2). The capability to partially open fuel injection passages at certain needle lifts are essential for organizing advanced combustion modes where only certain fuels are desired at different fuel injection timings. Other design configurations are possible, such as partially covering and uncovering the fuel injection passages at nozzle body at different needle lifts, or, through varying the pressure levels at the fuel injection passages in needle valve and nozzle body separately, etc.

The following sections give a detailed discussion related to three exemplary embodiments of the fuel injectors of this invention. In the following discussion, we use gasoline to represent low viscosity fuel, use diesel to represent high viscosity fuel. This does not intend to limit the applications of the invention. Thus, gasoline can be replaced by ethanol, liquid natural gas (LNG) or other low viscosity fuels. Diesel fuels can be replaced by biodiesel fuels, or even gasoline with lubricity additives.

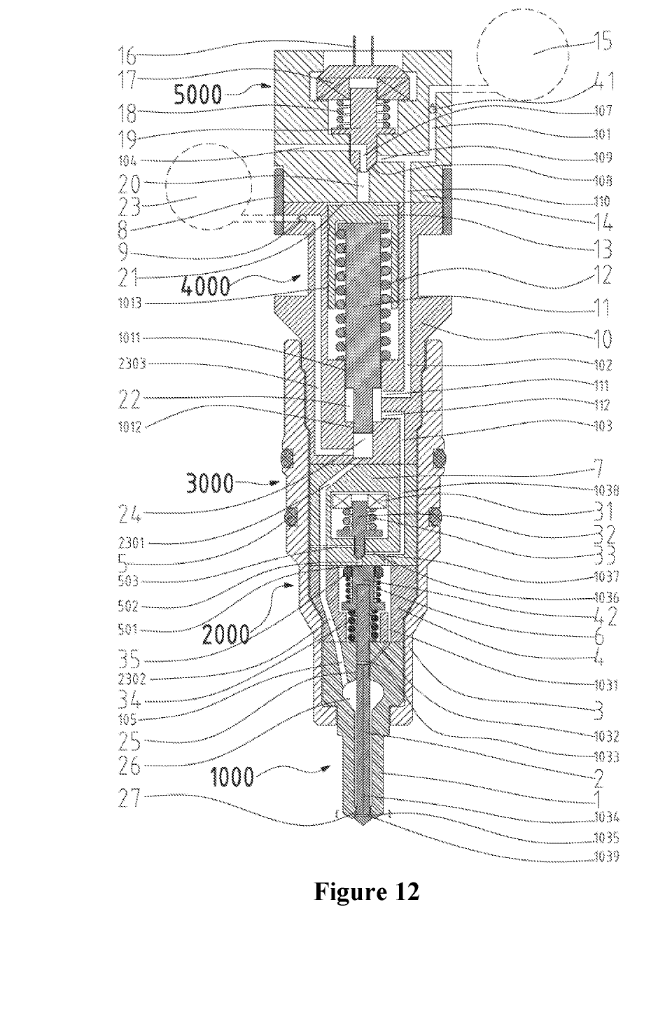

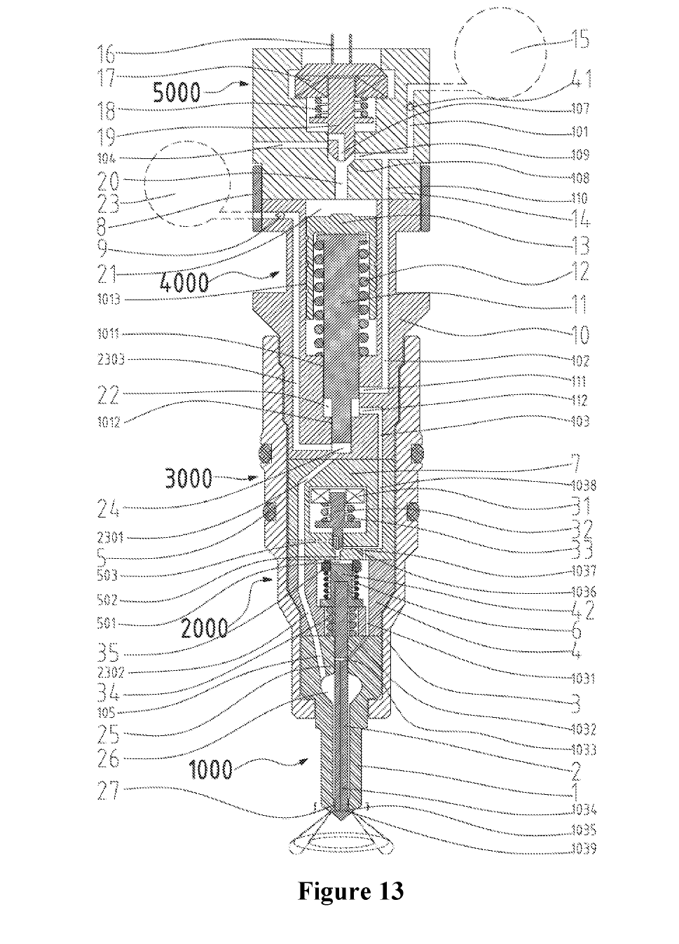

FIGS. 12 and 13 is cross-sectional views of a first exemplary embodiment of an injector of the invention, referred as multi-fuel common rail injector.

Referring to FIG. 13, low pressure gasoline flows into the fuel injector from a low pressure fuel rail or reservoir (23) through fuel passage (2303) and is filled in the pressure intensification chamber (24). When the solenoid valve (17) for pressure intensifier is not energized, the control valve plunger (19) is closed, pressurized diesel fuel is filled in the diesel intensification chamber (22) through passages (101, 110, 102, 111) and is guided through fuel passages (112, 103, 1038, 1036) to needle lift control chamber (501), through passages (1038, 1037, 1031, 1032, 1033) to needle tip along the fuel passage in needle center (1034) and small needle injection passage (1035). When needle control valve (31) is not energized, the control valve plunger (32) blocks fuel flow, the needle (2) is at seating position, no fuel is injected.

When the solenoid valve (17) is energized, the control valve plunger (32) was lifted up, high pressure diesel fuel or other high viscosity fuel from common rail (15) flows into intensifying chamber (21) through fuel passages (101, 109, 20), pressure intensifier piston (13) and intensifier plunger (11) are intensified and are pushed downward quickly, both the gasoline and diesel fuel in the intensification chambers (22, 24) are pressurized. The check valve (9) blocks gasoline backward flow, the gasoline pressure in nozzle chamber raises. And the sliding surface (1101) of plunger (11) blocks the back flow of fuel in chamber 22. The needle control solenoid valve (31) is than energized, the high pressure fuel is charged into needle pressure control chamber (501) and conquers the upward force of the spring (34), the nozzle needle (2) is lifted up outwardly, fuel injection begins and the rest processes are similar to FIG. 6. After metering the desired injection fuel quantity based on pulse-width map, the solenoid valves (31) closes, and pressure in needle control chamber (501) raises. At the same time intensifier control solenoid valve (17) is de-energized, control valve (19) closes. Partial fuel from intensifying chamber (21) flows into low pressure fuel passage (104) through fuel passage (20, 107), the pressure in the intensifying chamber (21) reduces. The pre-pressed plunger spring (12) pushes back the intensifier piston (13) to a stop position. The spring (6) and pressure in needle control chamber on top of nozzle needle (2) conquers the reduced lifting force by pressure in nozzle chamber (25), The spring (34) under the nozzle needle (2) conquers the reduced pressure force, the needle (2) returns to seat, fuel injection ends. In practice, depending on specific control circuit design, there may be a time phasing between the closing of intensifier control solenoid (17) and needle control solenoid (31).

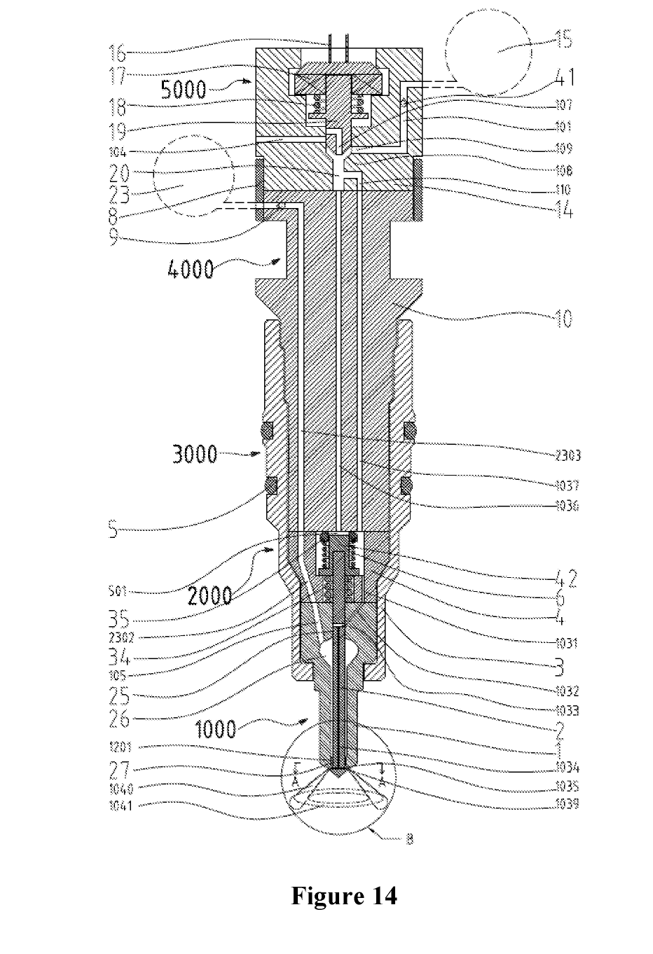

Referring to FIG. 14, which presents a simplified fuel injector without fuel intensifier. The operating mechanism is same as fuel injector of FIG. 6, except without fuel intensifier.

By switching the supply line of gasoline and diesel through a 2-way solenoid valve, the multi-fuel injector can be a single fuel injector with fuel injection modulated at different pressure level. By different configurations for the pressure intensifier area ratios as shown in FIG. 4, and materials, the injector can be customized for different dual-fuel/multi-fuel combinations, including gasoline-diesel, ethanol-diesel, ethanol-biodiesel, LNG-diesel, etc. The disclosed injector design is modular and adaptable.

FIG. 6 illustrates another example of embodiment. The work mechanism has been covered in the fuel injection method section above, and will not repeat it here.

The examples of embodiments are intended to illustrate the key structures and mechanisms, and should not be considered as limitations of the invention scope. For example, the electronic control valves used for pressure intensifier and needle lift control can be a solenoid valve or a piezoelectric actuator, or any other rapidly switching actuating unit know to those skilled in the art. For another example, the variable orifice nozzle can have a single needle valve as illustrated in FIG. 6, or dual needle valves as illustrated in PCT/US11/56002. Other type of injection nozzles such as an outward-opening puppet valve nozzle with needle modified to bear internal fuel passages can also be used.

We claim:

1. A fuel injection method, comprising steps of: (i) supplying a fuel injector with at least one low pressure fuel with low viscosity, (ii) using a pressurized fuel with high viscosity from a pressure reservoir to intensify said low viscosity fuel in an intensification chamber within the fuel injector through a pressure intensifier having piston surfaces facing high viscosity fuel and low viscosity fuel, (iii) directly injecting the intensified low viscosity and high viscosity fuels into a combustion chamber through the fuel injector.

2. A fuel injection method, comprising steps of: (i) supplying at least one type of fuels to fuel passages in nozzle body and needle valve of a fuel injector, (ii) lifting needle valve at different lifts, (ii) injecting at least two sprays of fuels with at least one spray exiting from the fuel injection passages from nozzle needle valve and another spray exiting from the fuel injection passages from nozzle body, (iii) interacting fuel sprays at nozzle orifice exits such that different fuel sprays patterns and angles are formed to fit for different injection timings.

3. A fuel injection method of claim 1, further comprising steps of: supplying a fuel injector with multiple low pressure fuels with different viscosities, cetane numbers, and octane numbers, into pressure intensification chambers, and directly injecting the intensified fuels with different cetane numbers and octane numbers into combustion chamber through a fuel injector.

4. A fuel injection method of claim 1, further comprising steps of spraying fuels with different cetane number and octane number separately and directly into combustion chamber.

5. A fuel injection method of claim 1, further comprising steps of supplying high viscosity fuels to lubricate sliding surfaces of the fuel injection devices contacting low viscosity fuels.

6. A fuel injection method of claim 1, wherein the low viscosity fuels are at least one of gasoline fuels, ethanol fuels, and mixture of gasoline and ethanol, and the high viscosity fuel is a type of diesel fuels, biodiesel fuels.

7. A fuel injection method of claim 1, wherein the low viscosity fuels are at least one of liquid natural gas, compressed natural gas fuels, and the high viscosity fuel is a type of diesel fuels, biodiesel fuels.

8. A fuel injection method of claim 1, wherein the low viscosity fuels are gasoline like fuels, water solutions, and the high viscosity fuel is a gasoline like fuel with an added lubricant enhancer.

9. A fuel injection method of claim 1, wherein the low viscosity fuels are injected at lower injection pressure than the high viscosity fuel.

10. A fuel injection method of claim 1, wherein the low viscosity fuels are injected at higher injection pressure than the high viscosity fuel.

11. A fuel injection system, comprising a high pressure fuel loop circulating fuel with high lubricity, and a low pressure fuel loop supplying fuel with low lubricity, wherein said high pressure fuel loop is comprised of at least one high pressure fuel pump and a high pressure common rail, wherein said low pressure fuel loop is comprised of at least one low pressure fuel pump to supply low pressure fuel, a set of fuel injectors wherein the low lubricity fuel is being pressurized by high lubricity fuel within said fuel injectors through a pressure intensifier, and part of the high lubricity fuel and low lubricity fuels are being directly injected into an engine combustion chamber, an engine control unit (ECU) to control the fuel delivery and injection process.

12. A fuel injector, comprising:
(i) a nozzle body (1) comprising fuel supply passages connected to at least one pressurized fuel reservoir, an inner cylindrical space within said nozzle body for receiving a needle valve (2), and a plurality of fuel injection passages (27) to introduce fuel into combustion chamber, and a valve seat (1050), and
(ii) a needle valve (2), which has an longitudinal fuel passage (1034) within and has a plurality of fuel injection passages (1039) to inject fuel, said needle valve is movable back and forth and partially received in said nozzle body, said needle valve has a diverging-converging arrow-shape needle head which is larger than the narrowest part of the nozzle inner space, said needle head bears a seal surface (1050′) which can engage with said valve seat (1050) and which guides fuel sprays, wherein said needle valve is at a biased closing position with its seal surface being pressed against the valve seat at said nozzle body (1) to block fuel flow from both said fuel injection passages on said needle valve and said nozzle body, or at an opening position through lifting the said needle valve seal surface outwardly away from said nozzle valve seat to inject fuel from fuel injection passages in both needle valve and nozzle body, and
(iii) an nozzle orifice (1035) for mixing and discharging the fuels from the fuel injection passages from said needle valve and said nozzle body in variable spray patterns through the gap between said needle valve and said nozzle body by lifting said needle valve outwardly at different lifts away from said valve seat.

13. A fuel injector of claim 12, wherein it has fuel supply passages connected to a single type of fuel, with pressurized fuel being supplied to the fuel injection passages in nozzle body and said needle valve respectively, wherein these two fuel injection streams are mixed and injected through said nozzle orifice (1035).

14. A fuel injector of claim 12, wherein it has separate fuel passages connected to two type of fuels, with one type of fuel being supplied to the fuel injection passages in nozzle body while another type of fuel being supplied separately to fuel injection passages in said needle valve, wherein these two fuel streams are mixed and injected through said nozzle orifice (1035).

15. A fuel injector of claim 12, referred as a fuel injector with an pressure intensifier, comprising: (i) a pressure intensifier, wherein it has means to intensify fuels with different viscosities and cetane numbers, with at least one high viscosity fuel being used to intensify low viscosity fuels to high pressure for directly injecting into combustion chamber, wherein there are multiple pressure intensification chambers and a cylindrical piston comprising different diameters with faces and shoulder surfaces having different sizes, with at least one surface facing and being driven by a high viscosity fuel, and at least one of the other piston faces and shoulder surfaces facing and pressurizing low viscosity fuels, (ii) an electronic control valve to control fuel flows from a pressurized fuel reservoir into an intensifying chamber of the said pressure intensifier and pressurize and depressurize the fuels in the pressure intensifier according to predefined electronic control valve positions.

16. A fuel injector of claim 15, refereed as a multi-fuel common rail injector, further comprising: (i) an electronic control valve to control the needle valve lift of the injection nozzle, (ii) fuel passages supplying high viscosity fuels to needle sliding surfaces, wherein it has means of directly injecting fuels with different viscosities and cetane numbers into an engine combustion chamber.

17. A fuel injector of claim 15, refereed as a multi-fuel unit injector, further comprising: (i) at least one spring to passively control the needle valve lift of the injection nozzle, (ii) fuel passages supplying high viscosity fuels to needle sliding surfaces, wherein it has means of directly injecting fuels with different viscosities and cetane numbers into an engine combustion chamber.

18. A fuel injector of claim 12, wherein the fuel injection passages in nozzle body are open fuel channels bearing an angle greater than zero to the longitudinal axis of said needle valve.

19. A fuel injector of claim 12, wherein the fuel injection passages in nozzle body are closed fuel holes, fuel passages in said needle valve are tangentially distributed to generate a swirl motion for injected fuel.

20. A fuel injector of claim 12, comprising,
a variable annular ring aperture (1035) between said needle valve and said nozzle body through lifting said needle valve outwardly away from nozzle seat at different lifts such that fuels are dischargeable in variable sprays of hollow conical and multiple jets shapes and variable spray angles through said variable annular ring aperture and through setting injection pressure at different levels to produce different spray momentum for fuel sprays coming out from fuel injection passages in said nozzle body and said needle valve.

21. A fuel injector of claim 12, comprising,
(i) fuel injection passages in needle valve wherein their exits can be covered and uncovered by nozzle body sliding surfaces (1201) through lifting said needle valve outwardly away from nozzle seat at predetermined lifts such that fuels are dischargeable in different flow rates and mixture compositions through said fuel injection passages;
(ii) an electronic actuator to control said needle valve lifts.

22. A fuel injector of claim 12, comprising,
at least one fuel injection passage in said nozzle valve and said nozzle body can be partially covered and uncovered at certain predetermined needle lifts to give different fuel injection rates for at least one type of fuel coming out of said fuel injection passages.
